(19) United States
(12) Patent Application Publication
(10) Pub. No.: US 2026/0285157 A1
(43) Pub. Date: Sep. 24, 2026

(54) DEVICE FOR THE OPERATION OF VEHICLE FUNCTIONS

(71) Applicant: MERCEDES-BENZ GROUP AG, Stuttgart (DE)

(72) Inventor: Michael OTTE, Ettlingen (DE)

(21) Appl. No.: 19/118,462

(22) PCT Filed: Sep. 15, 2023
(86) PCT No.: PCT/EP2023/075535

§ 371 Date: Apr. 4, 2025

(30) Foreign Application Priority Data
Oct. 5, 2022 (DE) 10 2022 003 665.7

(51) Int. Cl. B60K 35/53; B60K 35/10; B60K 35/25; B60K 35/80; B60N 2/02; B60R 16/037; G06F 3/01; G06F 3/041

(52) U.S. Cl. CPC B60K 35/53; B60K 35/10; B60K 35/25; B60K 35/80; B60N 2/0233; B60N 2/0248; B60N 2/0273; B60R 16/037; G06F 3/016; G06F 3/041; B60K 2360/111; B60K 2360/141; B60K 2360/143; B60K 2360/345; B60K 2360/731; B60K 2360/741; B60K 2360/794; G06F 2203/04105

(57) ABSTRACT

A device for the operation of functions in a vehicle includes a control panel arranged in the vehicle such that it can move locally. A drive for moving the control panel is connected to a controller, with the controller furthermore being connected to a touch- or approach-sensitive adjusting element. The controller is configured to activate the drive if the adjusting element is approached or contacted and, if the position of the approach or contact changes, to move the control panel analogously thereto.

### BACKGROUND AND SUMMARY OF THE INVENTION

Exemplary embodiments of the invention relate to a device for the operation of functions in a vehicle.

For the operation of vehicle functions, vehicles have a wide variety of input means such as rotary controllers, sliders, knobs, keys, touch-sensitive displays and the like. Depending on the geometric design of the vehicle, the user's body size, and seating position, individual input means may be easy to reach or harder to reach.

In particular, in the course of automated and autonomous driving, a vehicle driver is not required to continually assess the traffic situation and control the vehicle. This also allows the driver to adopt a more comfortable sitting position, such as a reclining position. As a rule, in such a sitting position, the input means mounted on a dashboard such as central display of the head unit or input means mounted on a front part of a vehicle door such as electric window controls or knobs for performing seat adjustment can no longer be reached. Accordingly, operator control actions can no longer be performed via these input means. This creates the need for means to solve this problem.

An operator control element and an interface for a vehicle computer are known from DE 10 2005 014 939A1. The operator control element is designed like a computer mouse. In this case, guides are provided to restrict the freedom of movement of the operator control element, which, for example, prevent the operator control element from coming off a support surface. To make is easier to reach the operator control element, the position of the operator control element can be moved in the direction of the vehicle longitudinal axis. For this purpose, latching means are provided, which can be actuated to manually move the operator control element.

In addition, DE 10 2013 202 932 A1 discloses a door panel with a longitudinally moveable carrier, comprising a receiver for a mobile device. The carrier can be moved by physical strength. The carrier can also comprise a display. The display can be embodied as a touchscreen for operating a vehicle function, such as the air-conditioning system.

In addition, DE 103 24 918 A1 discloses a control device and operating device of the control device of an adjusting device of a motor vehicle. The publication describes a touch-sensitive operator interface for detecting operator control actions. The adjusting device can be controlled via the operator interface. A window controller and/or an adjustable wing mirror are examples of adjusting devices that can be controlled. In this case, a control path and an adjustment path or respectively a control position and an adjusting position correlate with each other. The operator interface is integrated in the front area of a vehicle door facing the vehicle interior.

In addition, DE 10 2016 212 813 A1 discloses a vehicle having an operator control and display device and a method for operating such a vehicle. This display device can be part of a side window in the vehicle. A vehicle occupant's position is determined using a detection device and the display content of the display device is displayed at the vehicle occupant's position in relation to the vehicle longitudinal axis. By touching a light strip integrated in the vehicle door below the side window, the display content can be moved on the display device.

In addition, DE 10 2020 209 072 A1 discloses a vehicle door with a multi-functional operator control element. The operator control element comprises a first operable component for operating a first vehicle function, for example, a window activation function, and can be moved manually relative to the vehicle door in order to operate a second vehicle function, for example a door activation function.

In addition, DE 10 2020 005 333 A1 discloses a method for generating haptic feedback on a touch-sensitive operator interface. In this case, a friction coefficient between a finger and the operator interface can be adapted in a location-dependent manner.

In addition, DE 10 2018 222 869 A1 discloses an operator control system for a vehicle and a method for operating the operator control system. The operator control system comprises a seat position detection unit, an operator control unit, and a control unit. The operator control unit has a first and second detection area. The control unit controls the operator control unit to provide the first or second detection area depending on user's seat position.

In addition, DE 10 2014 019 125 A1 discloses controlling a device as a function of a seat inclination. The publication describes the automatic tilting of a display integrated in the armrest of a vehicle seat as a function of an inclination of the backrest.

In addition, CN 1 12 498 189 A discloses a vehicle seat linkage control system. It describes linking a vehicle seat position to an operator control element position.

In addition, CN 1 10 853 187 A discloses a method and a device for unlocking a vehicle door as well as a storage medium and a vehicle.

Furthermore, CN 1 03 526 991 A discloses a vehicle door lock control system and a method for operating same.

Exemplary embodiments of the present invention are directed to an improved device for the operation of functions in a vehicle, which can be reliably reached in a particularly comfortable manner in various situations.

A generic device for the operation of functions in a vehicle, comprising a control panel which is arranged in the vehicle in such a way that it can move locally, is refined according to the invention in that a drive for moving the control panel is provided, which is connected to a controller, with the controller furthermore being connected to a touch- and/or approach-sensitive adjusting element, wherein the controller is configured to activate the drive if the adjusting element is approached or contacted and, if the position of the approach or contact changes, to move the control panel analogously, i.e., corresponding, thereto. The adjusting element is set apart from the control panel and is arranged in the vehicle such that the adjusting element can be reached from any seat position merely by a user raising their arm.

Using the device according to the invention, a user is able to operate functions in the vehicle particularly comfortably, independently of a respective relative orientation of the user with respect to the control panel. The user is thus able to flexibly adjust the position of the control panel in the vehicle by means of the adjusting element, according to their situation-specific preference. The adjustment is effected automatically via the actuator, without any need to move the control panel manually. Merely the adjusting element needs to be actuated. The use of a touch-sensitive or approach-sensitive adjusting element makes for a particularly comfortable user experience. Inputs made via the adjusting element are processed by the controller and used to control the drive.

The control unit, referred to as a controller, is configured to control output means such as the drive for moving the control panel. The control unit is a hardware device having a processor preferably designed as an integrated circuit, which uses data and/or programs, saved in a ROM (Read Only Memory), RAM (Random Access Memory) and/or FlashROM memory, for example, to perform computing operations. The data output by the adjusting element are buffer-stored in a memory of the control device as required and retrieved by the processor via an internal bus system and processed. The output data for moving the control panel, computed by the processor on the basis of the output data from the adjusting element are output to the drive via an output circuit of the control device.

By changing the position of the initial touching or approaching of the operating element, referred to as adjusting element, it is ensured that the control panel is correspondingly moved particularly intuitively. The change in the position of the approach is in other words understood to mean the path travelled by an operating means, for example a finger, that has been recognized as approaching or touching the control panel. A position change is effected by the operating means being moved from a first position—recognized as having been approached or touched—to a further position without coming off, i.e., without the approach or touching being interrupted. In the present case, the corresponding movement includes a movement that corresponds fully to the position change and/or a movement that is scaled to the position change, whereby a sensitivity of the adjusting element is replicated, as it were. When a finger that has approached or is touching the control panel changes position, the control panel is moved exactly in line with the position change. If the movement is scaled, the control panel is moved by a position changed multiplied by a scaling factor of less than, greater than or equal to 1. Thus, the position change of the touching or approaching of the adjusting element corresponds to the movement sequence or the direction in which the control panel is moved. This reliably and comfortably prevents the control panel from being inadvertently moved in the wrong direction, which can easily occur, for example, if a knob or switch has been used as an adjusting element.

To make the adjusting element touch-sensitive or approach-sensitive, one or more sensors can be integrated in the adjusting element, such as, for example, capacitive touch sensors, a surface acoustic wave (SAW) sensor system, and/or a force sensor system based, for example, on microelectromechanical systems (MEMMS). This enables accurate position detection of finger that is used by the user for the operation. It is furthermore possible as a result to make a distinction between a localized touching or approach of the adjusting element, for example by means of a finger, and a large-area touching or approach, for example by means of the entire hand.

The controller comprises or is designed as a control device, which is a hardware device with a processor, preferably designed as an integrated circuit, which uses data and/or programs saved in a ROM (Read Only Memory), RAM (Random Access Memory) and/or FlashROM memory, for example, to perform computing operations. The data output by the touch- and/or approach-sensitive adjusting element are buffer-stored in a memory of the control device as required and retrieved by the processor via an internal bus system and processed. The output data for moving the control panel, determined by the processor, are output to the drive via an output circuit of the control device.

The adjusting element is set apart from the control panel, as described above. Set apart in this context means that the adjusting element is designed in two parts with the control panel and is arranged at a certain distance from the control panel in the vehicle. The adjusting element can be used to move the control panel translationally such that the control panel can easily be reached by a user again. Accordingly, the adjusting element should be easy to reach from the respective seat position of the user so that the control panel can also be brought towards the user. This can be safely ensured for a wide variety of vehicle configurations when the control panel and adjusting element are arranged spatially separate and mutually spaced apart.

In this case, the adjusting element is arranged in the vehicle such that it can be comfortably reached by a user in a seating configuration in which the control panel cannot typically be comfortably reached, for example during normal driving.

One advantageous refinement of the device provides that the drive is designed as a linear drive to move the control panel in a longitudinal direction that is substantially parallel to the direction of travel of the vehicle. Typically, the driver will be able to comfortably reach operating elements mounted in the front area of the vehicle, for example, operating elements installed on or in the dashboard or operating elements installed in the front region of a vehicle door, from a typical seat position. Comfortably in this context means in particular that the vehicle driver can reach the corresponding operating element merely by raising their arm and thus, for example, does not need to also bend forwards or to the side from their seat. If however a reclining position has been adopted, then the driver is leaning back in the direction of the vehicle longitudinal axis away from dashboard. In such a seating configuration, it is necessary to also move the control panel towards the rear in the direction of the vehicle longitudinal axis. Linear drives represent a particularly robust, reliable and cost-effective solution for the translational movement of the control panel.

A further advantageous embodiment of the device furthermore provides that the controller is configured to adapt the relationship between the change in the approaching or contacting of the adjusting element and the adjustment path of the control panel on the basis of a specified value. In other words, a sensitivity can be set for the adjusting element. The sensitivity can be used to define by how much the control panel is to be moved translationally, depending on a fixed position change of the approaching or touching of the adjusting element. With a low sensitivity, a position change of, for example, 5 cm will only move the control panel 2 cm or 4 cm and with a high sensitivity, it will be moved 8 cm or 12 cm, for example.

To set the sensitivity, various selection options such as a (level-based) high, medium and low sensitivity can be specified. The sensitivity can also be changed continuously using a slider.

Various user settings can be saved in the vehicle, for example, in a submenu of an infotainment system. These user settings can be assigned to a user profile. A user can be recognized, for example, via biometric features such as an iris scan, a fingerprint scan, a voice analysis, a face scan, or the like. A user can also be recognized by registering by means of username and password or via detection of an object that they are carrying about their person, such as a particular transponder, vehicle key or else mobile device, for example, the user's smartphone that can be identified via its unique Bluetooth ID or Mac address. The sensitivity can be saved and assigned to the respective user profile.

A sensitivity setting possibly preferred by a user can also be derived from the vehicle based on other user settings that have been made and/the user behavior observed during driving. For this purpose, artificial intelligence can be executed on a control device in the vehicle and used to evaluate the user setting and/or the user behavior. If the user has, for example, also selected a high sensitivity for other vehicle functions, then the artificial intelligence can also select a high sensitivity for moving the control panel. This user preference can however also be derived from other parameters, for example from the driver's driving style. If the driver tends to have a sporty driving style, for example, then a high sensitivity can be selected; a low sensitivity can be selected for a more defensive driving style.

In particular, the sensitivity can be designed to be variable when the adjusting element is being operated. If, for example, the user moves their finger along the adjusting element quickly, a high sensitivity and therefore a long adjustment path is selected for the control panel. If, by contrast, the user moves their finger slowly along the adjusting element, then the control panel correspondingly moves more slowly or less far. This feature can be compared to what is known as “mouse acceleration” of a computer mouse, for example.

In accordance with a further advantageous embodiment of the device, the adjusting element has a lighting assembly, wherein the controller is configured to light up the adjusting element differently in the event of an intentional actuation-caused by a detected approach or touching, preferably in connection with the position change than in the event of a standby mode. This is an especially effective way of increasing user convenience. The adjusting element can be directly recognizable or also hidden lighting elements. Direct lighting can be created by means of the directly recognizable lighting elements and an indirect lighting can be created by means of the hidden lighting elements. The lighting elements can emit white or also colored light. Continual light or else dynamically changing light can be generated thereby. By means of such lighting, it is easy to locate the adjusting element in the vehicle interior, in particular in poor light conditions such as in darkness. The lighting can be changed depending on various boundary conditions. If, for example, the adjusting element is touched, so can the light pattern generated via the lighting element(s) can be adapted. For example, the color portrayed can be changed, for example, from white to blue, and/or a continual light can be set to flash at a particular frequency. Changes to color and/or brightness are preferably gradual and in particular animated. If, for example, the user moves their finger along the adjusting element, then the adjusting element can light up in the area of the touch or contact surface. While the finger moves along the adjusting element, the area that is contacted by the finger and thus illuminated along the adjusting element is traced with the finger during the movement.

A further advantageous embodiment of the device furthermore provides that the control panel has a lighting assembly, wherein the controller is configured to activate the lighting of the control panel and/or to change the type of lighting at least when an actuation of the adjusting element has been detected. This also improves user comfort. This function enables, for example, a user of the device according to the invention to locate the control panel in the vehicle even more easily. For example, multiple different control panels can be moved by means of the same adjusting element, wherein the control panel which can be moved translationally by receiving user input via the adjusting element is the one that has its lighting changed. If the user touches the adjusting element or approaches same, then a backlighting of the control panel can be activated, for example, or a white backlit control panel can be backlit in color, for example in red, green or blue. If there are multiple control panels, the lighting of the control panel that is intended to be moved is activated, or the adjusting element glows in a particular color, for example blue, and the control panel that is intended to be moved is analogously lit up, likewise in blue. The control panel that is not intended to be moved then remains dark or glows in another color, for example white or yellow.

In accordance with a further advantageous embodiment of the device, the adjusting element has force sensors for detecting the contact force in the event of it being touched, wherein the controller is configured to recognize an actuation as being an actuation only once a contact force is above a specified threshold. This function means that operating errors can be avoided. For instance, the user could unintentionally approach the adjusting element during normal driving. This could result in undesired movement of the control panel. If, however, a certain amount of force is required to move the control panel, the controller thus becomes able to ignore such undesired unintentional touches. For example, one or more MIMS sensors can be integrated in the adjusting element to detect the respective contact force.

A further advantageous embodiment of the device furthermore provides that the adjusting element has actuators, in particular piezo actuators, wherein the controller is configured to excite the actuators to vibrate in order to generate haptic feedback in the event of a contact-based actuation by changing the friction between the contact point and a finger touching the adjusting element. This improves user convenience even further when the device according to the invention is being operated. For instance, the user may be distracted when driving the vehicle, for example by what is happening on the road. The user can be informed via the haptic feedback that they have actually touched the adjusting element with their finger, meaning that they can return their gaze to the road and still move the control panel. By using piezo actuators in contrast to, for example, vibrating masses, it is possible to realize a particularly natural haptic sensation. For this purpose, the individual piezo actuators can be placed, for example, in a grid or panel arranged along the adjusting element.

Preferably, the controller is furthermore configured to change the friction in such a way that a guide element, a grid and/or stops are simulated. The adjusting element can be embodied, for example, as a touch-sensitive slider. The haptic feedback can be used to inform the user of the track along which their finger should be moved along the adjusting element to move the control panel. For this purpose, for example, a guide element that is continuous along the movement path can be used to convey this information haptically. This guide element can also in particular be interrupted at regular intervals to convey the grid effect. In particular, the spacing between the individual grid elements is designed depending on the set sensitivity of the adjusting element. If, for example, a high sensitivity has been selected, these individual grid points are closer together, i.e., the spacings are shorter. Accordingly, the individual grid elements are further far apart if a low sensitivity has been selected. On reaching a front and/or rear end of the slider, i.e., the adjusting element, haptic feedback, preferably a particularly pronounced haptic feedback, can be output to indicate said stops to the user. This informs the user that the respective end of the slider has been reached.

For the design of the haptic feedback, piezo actuators and a control system for these piezo actuators, as sold by the company Hap2U, can particularly preferably be used.

A further advantageous embodiment of the device furthermore provides that the controller is configured to preset the position of the control panel and settings of a vehicle seat, to which the control panel is assigned, based on a saved or determined body size of a person using the vehicle seat. This can increase user convenience even further. The control panel is thus aligned with person's body dimensions when they sit down, whereby moving the control panel once more can possibly be dispensed with. However, the adjusting element can still be moved to make fine adjustments or readjust a changed seat position. The body size can be input manually or measured using vehicle-internal sensors, for example pressure sensors integrated in the vehicle seat and/or by means of interior cameras. The measured dimensions can be assigned to a user profile, meaning that the body dimensions will not need to be detected again. In this case, not only the entire body size, but also the length of individual limbs can be recorded in detail in order to enable an even more differentiated and therefore more precise alignment.

The respective user profile can be selected or activated as mentioned above by recording a biometric feature, manual selection or detection of the presence of a certain mobile end device in the vehicle.

Preferably, if the vehicle seat is adjusted, the controller is configured to move the control panel assigned to the latter in accordance with the adjustment. In other words, the control panel can be moved at the same time as the seating configuration is changed. If, for example, the respective vehicle seat is moved rearwards in the direction of the vehicle longitudinal axis and/or a backrest is tilted in a more inclined position, the control panel also travels rearwards in the direction of the vehicle longitudinal axis. It is then no longer necessary to move the control panel via the adjusting element when the seat position is adjusted, although this can still be done also for fine adjustment purposes.

A further advantageous embodiment of the device according to the invention furthermore provides that, if the vehicle seat is adjusted, the controller is furthermore configured to determine the movement data of a reference area of a backrest of the vehicle seat, wherein the control panel is moved analogously to the movement of the reference area. By means of this function, a particularly reliable automatic forward movement of the control panel is achieved. If the backrest of the vehicle seat is folded forwards or back, the region that can be reached by an outstretched arm, and thus the region that will be used for the control panel, will move towards the front or rear in the direction of the vehicle longitudinal axis.

The reference area can thus correspond to a horizontally extending segment of the backrest of the vehicle seat at a certain geodetic height. Preferably, this segment is level with the outstretched arm of the respective user. This height can also be measured using the vehicle-internal sensor system.

The control panel is preferably arranged in a vehicle door, wherein the reference area corresponds to an area in the backrest of the vehicle seat that is level in terms of height with the control panel. When the vehicle seat is adjusted, the reference area thus moves up and down along the backrest. In relation to the vehicle vertical axis, the height of the reference area is constant, however. Since the user actuates the control panel with their arm outstretched, it can also be used directly to determine the position of the reference area along the backrest of the vehicle seat.

A further advantageous embodiment of the device according to the invention furthermore provides that the adjusting element is arranged in the region of a door handle of the vehicle door, in particular in a trim element located there. The region of the door handle of the vehicle door can be reached particularly easily by the user in the vehicle. In particular, it is thus possible to uniquely assign adjusting element to vehicle seat. If, for example, the adjusting elements for the driver's seat and the front passenger seat are integrated in the center console, this could be confusing and the front passenger could inadvertently actuate the adjusting element for the driver's seat, for example. In addition, the region of the vehicle door can be reached both in a seat configuration set forwards in relation to the vehicle longitudinal axis and seat configuration that is set towards the rear.

Preferably, the adjusting element is shaped so as to be elongated in the direction of the vehicle longitudinal axis, wherein a change in the position of the approach or contact can be determined at any point along the adjusting element. The elongated shape means that the adjusting element can be designed particularly favorably as a slider. The elongated shape guarantees a comparatively longer adjustment path. In addition, the adjusting element can be reached particularly easily from various seating configurations. The position at which the adjusting element is initially touched or approached is not relevant to deriving control commands for moving the control panel. Only the position change is relevant for determining the control commands. For example, an operating of the adjusting element can be operated starting in the front fifth up to halfway along the adjusting element in relation to its length, or also starting in the last third of the adjusting element and reaching up to its rear end.

### BRIEF DESCRIPTION OF THE DRAWING FIGURES

Further advantageous embodiments of the device according to the invention for the operation of vehicle functions will also become apparent from the exemplary embodiments, which are described in more detail hereinafter with reference to the figures, which show:

FIG. 1 four schematic illustrations of a device according to the invention integrated in a vehicle door at various points in time of an operator control sequence;

FIG. 2 a schematic section view though an adjusting element the device according to the invention;

FIG. 3 three schematic plan views of the adjusting element while different haptic feedback is being output; and

FIG. 4 a schematic side view of a vehicle seat with associated control panel in various seating configurations.

### DETAILED DESCRIPTION

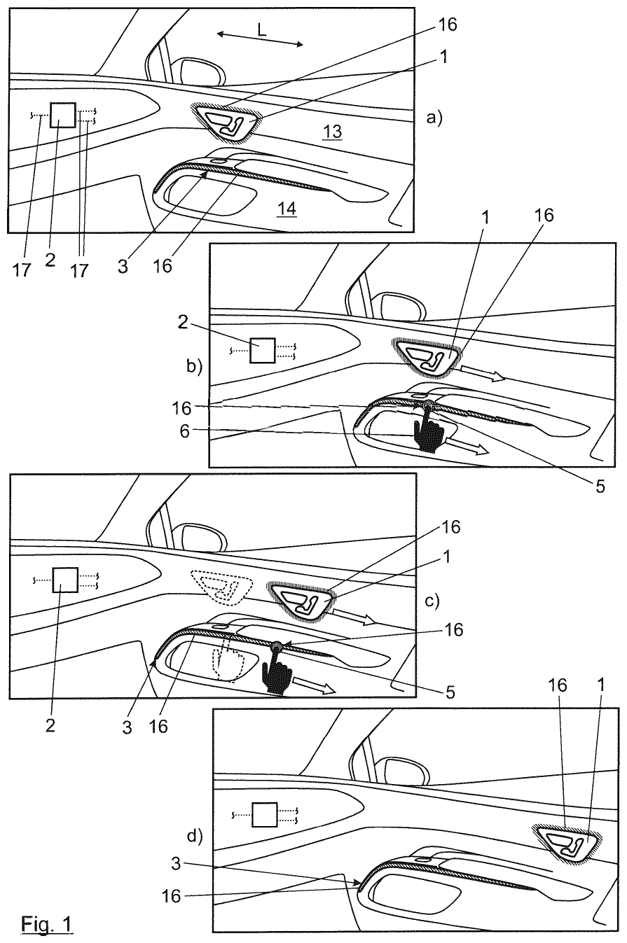

FIG. 1 shows an interior view of a vehicle that focuses on a vehicle door 13, here the front passenger door. The figure shows a control panel 1 and an adjusting element 3, integrated in a door handle 14 of the vehicle door 13, for the translational movement of the control panel 1 in a longitudinal direction L extending in the direction of the vehicle longitudinal axis. User inputs that are registered via the adjusting element 3 are processed by a controller 2 for the purpose of deriving control commands for controlling an actuator (not shown in more detail) for moving the control panel 1. The controller 2 is connected via a data line 17 such as a CAN bus to the actuator, the adjusting element 3 and further vehicle components such as control devices or a central onboard computer.

FIG. 1a) shows the control panel 1 and the adjusting element 3 in an idle mode or standby mode. In particular, lighting elements are integrated in the control panel 1 and the adjusting element 3 for generating direct and/or indirect lighting. In the standby mode, for example, a blue continuous light is emitted from the control panel 1 and the adjusting element 3. Preferably, lighting atmosphere thus created is adapted to any other lighting in the vehicle, for example so-called ambient lighting. By means of a light pattern 16 generated in such a way, control panel 1 and adjusting element 3 can be located in the vehicle interior particularly easily.

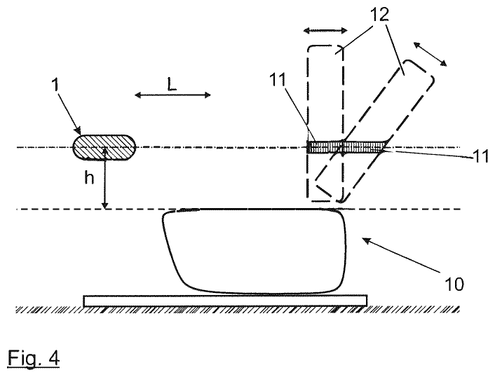

User inputs can be received via the control panel 1 to operate numerous vehicle functions. For example, as illustrated in FIG. 1, knobs are integrated in the control panel 1, using which a seat configuration can be changed. As a result, for example, a corresponding vehicle seat 10, shown in more detail in FIG. 4, can be moved forwards or backwards in the longitudinal direction L, its backrest 12 can be put upright or tilted back or the entire vehicle seat 10 can be moved translationally in the direction of the vehicle vertical axis, which is not shown in more detail.

If the vehicle seat 10 and/or the backrest 12 is now changed to a set-back seating configuration, a user seated on the vehicle seat 10 might not be able to reach the control panel 1 anymore. By actuating the adjusting element 3, however, the control panel 1 can be moved in the longitudinal direction L rearwards towards the user, so that the user can comfortably reach the control panel 1 again. The corresponding operating procedure is shown in the subfigures b), c) and d).

In FIG. 1b), the user touches the adjusting element 3 with a finger 6 at any position. Preferably, the adjusting element 3 has a design that is elongated in the direction of the vehicle longitudinal axis, which enables the user to comfortably reach at least a region of the adjusting element 3, irrespective of their seat position. In the exemplary embodiment shown in FIG. 1b), the finger 6 touches the adjusting element 3 at a contact point 5. According to one design of the device according to the invention, the lighting can then be adapted by control panel 1 and adjusting element 3. A light pattern 16 is thus emitted in the region of the contact point 5 in the style of direct illumination via the lighting elements arranged in the adjusting element 3. This signals to the user that the adjusting element 3 has detected that the user has touched it.

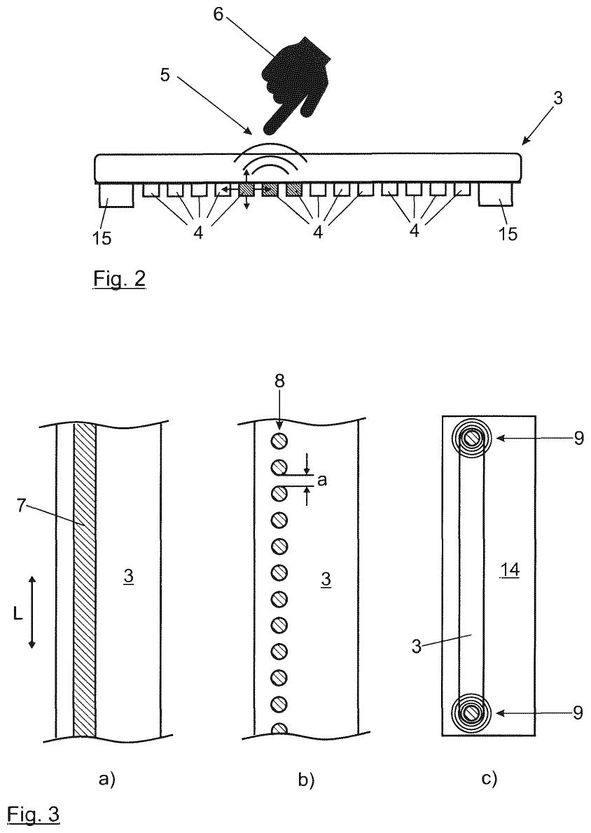

To detect contact, the adjusting element 3 can have various sensor elements such as capacitive touch sensors and/or surface acoustic wave sensors 15 shown in FIG. 2.

The adjusting element 3 can be touch-sensitive and/or also approach-sensitive. For this purpose, the adjusting element 3 can have sensors such as radar sensors, ultrasonic sensors, laser scanners, cameras, or the like. In this case, an actuation of the adjusting element 3 can be detected by the controller 2, even if only an approach of the finger 6 towards the adjusting element 3 is detected.

The light emitted by the control panel 1 can stay constant or be changed during operation of the adjusting element 3. For example, a flashing light pattern 16 or a moving light pattern 16 can be emitted, in particular a light pattern 16 that simultaneously moves in the direction of the moving finger 6.

FIG. 1c) shows the movement sequence of the finger 6 along the adjusting element 3. The finger 6 is moved rearwards in the longitudinal direction L, as indicated by an arrow. It can be seen that the direct lighting emitted at the contact point 5 follows the movement of the finger 6. The control panel 1 also moves analogously to the finger 6.

In FIG. 1d), the user removes their finger 6 from the adjusting element 3 and the control panel 1 has reached its desired position. The lighting from the control panel 1 and adjusting element 3 is changed back to the lighting emitted in the standby mode to output the corresponding light pattern 16.

FIG. 2 shows an enlarged illustration of the adjusting element 3 in a sectional view. In addition to the surface acoustic wave sensors 15, a plurality of piezo actuators 4 arranged along the adjusting element 3 can also be seen. These piezo actuators 4 extend preferably not only along the longitudinal extent of the adjusting element 3, but also transversely thereto in the direction of the vehicle transverse axis (not shown in detail), i.e., orthogonally to the plane of the page in relation to the figure. For this purpose, the piezo actuators 4 can be arranged in a grid. Haptic feedback can be output by means of the piezo actuators 4. This is preferably done in analogy to the technology developed by the company Hap2U. It is not the entire adjusting element 3 that vibrates, but merely the section touched by the finger 6 at the contact point 5 or certain predefined areas. This is indicated in FIG. 2 by the dark hatched piezo actuators 4. The piezo actuators 4 can vibrate up and down, to the side and in a direction orthogonal to the plane of the drawing. As a result, the friction between the finger 6 and a surface of the adjusting element 3 can be changed in a targeted manner in the regions acted upon by the activated piezo actuators 4, so that certain tangible structures on the surface of the adjusting element 3 can be simulated. This is illustrated in FIG. 3.

For example, FIG. 3a) shows a simulated guide element 7 parallel to the extension direction of the adjusting element 3, here the longitudinal direction L. The guide element 7 can be felt by the user with their finger 6 and feels like a groove or elevation. This informs the user of the direction in which they can move their finger 6 along the surface of the adjusting element 3 in order to make the control panel 1 move.

FIG. 3b) shows a grid 8 that is simulated by means of the haptic feedback. There is preferably a spacing a between the individual grid elements depending on a settable sensitivity of the adjusting element 3. In the case of a comparatively high sensitivity, a small spacing a is selected, and in the case of a comparatively large sensitivity, a larger spacing a is selected.

FIG. 3 c) shows a plan view of the entire adjusting element 3. A stop 9 is simulated by means of the haptic feedback in each of the end regions of the adjusting element 3. Compared to the individual grid elements of the grid 8, a particularly pronounced haptic feedback is preferably output here. This informs the user via the haptic feedback that a respective end of the adjusting element 3 has been reached. The simulated surface structures shown in FIGS. 3a), b) and c) can also be combined.

The control panel 1 can also move in the longitudinal direction L as a function of a seat adjustment. For this purpose, different seating configurations for various user profiles can be saved. The preferred position of the control panel 1 along its respective movement path is then also saved in a respective user profile. If the vehicle seat 10 is moved forwards or back or its backrest 12 is tilted forwards or back, then the control panel 1 can be moved analogously. This reduces the effort on the part of the user, since then they no longer need to actuate the adjusting element 3 to move the control panel 1. The adjusting element 3 can however still be used to finely adjust the position of the control panel 1.

Particularly preferably, the position of the control panel 1 is adapted depending on movement data of a reference area 11 of the vehicle seat 10 shown in FIG. 4. In this case, FIG. 4 shows a position of the reference area 11 on the backrest 12. The reference area 11 is located on the backrest 12 in a vertical direction, i.e., a direction parallel to the vehicle vertical axis at the same geodetic height h as the control panel 1. In the exemplary embodiment shown in FIG. 4, the height h is indicated in relation to a seat surface of the vehicle seat 10. However, the floor of the vehicle interior or the like could also serve as a reference.

As can be seen in FIG. 4, the reference area 11 is always at the same geodetic height h as the control panel 1. However, the reference area 11 moves up and down along the backrest 12 depending on the inclination of the backrest 12.

The height h of the control panel 1 is especially suitable for determining the position of the reference area 11 since the arm or the hand of the user is at this height h for operating the control panel 1. The control panel 1 then moves in line with the adjustment speed of the reference area 11 as viewed in the longitudinal direction L, which makes it possible to maintain a constant spacing between control panel 1 and reference area 11, and thus ensures that the user can comfortably reach the control panel 1.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-14. (canceled)

15. A device configured to operate functions in a vehicle, the device comprising:
a control panel arranged in the vehicle such that the control panel is locally moveable;
a drive configured to move the control panel;
a touch- or approach-sensitive adjusting element; and
a controller coupled to the drive and to the touch- or approach-sensitive adjusting element, wherein the controller is configured to
activate the drive when the touch- or approach-sensitive adjusting element is approached or contacted, and
when a position of the approach or contact changes, to move the control panel analogously to the changes of the position of approach or contact, wherein the touch- or approach-sensitive adjusting element is set apart from the control panel and is arranged in the vehicle such that the touch- or approach-sensitive adjusting element is reachable from any seat position by a user raising their arm.

16. The device of claim 15, wherein the drive is a linear drive configured to move the control panel in a longitudinal direction that is substantially parallel to a direction of travel of the vehicle.

17. The device of claim 15, wherein the controller is configured to adapt a relationship between the change in the approaching or contacting of the touch- or approach-sensitive adjusting element and an adjustment path of the control panel based on a specified value.

18. The device of claim 15, wherein the touch- or approach-sensitive adjusting element has a lighting assembly, wherein the controller is configured to light up the touch- or approach-sensitive adjusting element differently in event of actuation compared to a standby mode.

19. The device of claim 15, wherein the control panel has a lighting assembly, wherein the controller is configured to activate the lighting of the control panel or to change a type of lighting at least when an actuation of the touch- or approach-sensitive adjusting element has been detected.

20. The device of claim 15, wherein the touch- or approach-sensitive adjusting element has force sensors configured to detect a contact force in event of the touch- or approach-sensitive adjusting element being contacted, wherein the controller is configured to recognize an actuation as being an actuation only once the contact force is above a specified threshold.

21. The device of claim 15, wherein the touch- or approach-sensitive adjusting element has piezo actuators, wherein the controller is configured to excite the piezo actuators to vibrate to generate haptic feedback in event of a contact-based actuation by changing a friction between a contact point and a finger touching the touch- or approach-sensitive adjusting element.

22. The device of claim 21, wherein the controller is furthermore configured to change the friction in such a way that a guide element, a grid, or stops are simulated.

23. The device of claim 15, wherein the controller is configured to preset a position of the control panel and settings of a vehicle seat, to which the control panel is assigned, based on a saved or determined body size of a person using the vehicle seat.

24. The device of claim 23, wherein when the vehicle seat is adjusted, the controller is configured to move the control panel assigned to the vehicle seat in accordance with the adjustment.

25. The device of claim 24, wherein when the vehicle seat is adjusted, the controller is furthermore configured to determine movement data of a reference area of a backrest of the vehicle seat, wherein the control panel is moved analogously to movement of the reference area.

26. The device of claim 25, wherein the control panel is arranged in a vehicle door, wherein the reference area corresponds to an area of the backrest of the vehicle seat that is level in terms of height with the control panel.

27. The device of claim 26, wherein the touch- or approach-sensitive adjusting element is arranged in a region of a door handle of the vehicle door.

28. The device of claim 15, wherein the touch- or approach-sensitive adjusting element is shaped so as to be elongated in a direction of a vehicle longitudinal axis, wherein a change in the position of the approach or contact can be determined at any point along the touch- or approach-sensitive adjusting element.
